(19) United States
(12) Patent Application Publication
(10) Pub. No.: US 2003/0078793 A1
(43) Pub. Date: Apr. 24, 2003

(54) Enhanced customer-centric restaurant system

(76) Inventor: Mark E. Toth, Plymouth, MN (US)

Correspondence Address: Oppenheimer Wolff & Donnelly LLP, Suite 3300, 45 South Seventh Street, Minneapolis, MN, 55402-1609, US

(21) Appl. No.: 10/037,681

(22) Filed: Oct. 24, 2001

(51) Int. Cl. G06F 17/60

(52) U.S. Cl. 705/1

(57) ABSTRACT

A method and system for providing an automated, extremely efficient, restaurant experience for the customers of a sit-down style restaurant. The system and method of the present invention presents options to the customer which include, but are not limited to: a virtual server as part of the user interface allowing a customer to have a more human-like interaction with the restaurant communication system; a data mining analysis tool for analyzing transactions performed by the restaurant communication system; functionality to allow the restaurant diner to pay for the food and drinks with cash, a check, credit card, or a gift certificate; Internet access to the restaurant diner for receiving information on movies; the option to purchase movie theater tickets or gift certificates; a module to place an order from a remote location via the Internet; an incentive program to encourage the restaurant diner to order the food and the drinks; human resource capability for a restaurant; options to send Internet e-mail messages or messages to other diners; or voice recognition and voice synthesis to allow the restaurant diner to operate the restaurant communication system even with a vision impairment. The extreme versatility of the various embodiments of the present invention facilitate providing a highly customized system for any given restaurant business.

A computer program listing appendix containing computer source code is attached and is hereby incorporated by reference. The computer program listing appendix comprises one CD-ROM having the files listed in the Appendix A (located prior to the claims).

The computer program listing appendix contains material which is subject to copyright protection. The copyright owner has no objection to the reproduction of such material, as it appears in the files of the Patent and Trademark Office, but otherwise reserves all copyright rights whatsoever.

### BACKGROUND OF THE INVENTION

The present invention pertains generally to computerizing many of the tableside interactions a diner has with restaurant staff during a seated meal. In particular, the present invention relates to a computer network specialized for restaurants.

Computers and the Internet have had a tremendous impact on our society over the last decade and have significantly altered the average consumers expectation of customer service in most areas of commerce. Letters of inquiry have been replaced by e-mail. Catalogs have been replaced by websites. No longer does an average consumer find it acceptable to wait for a product to arrive in a local shop's stock before a purchase is made. Rather, the consumer accesses the Internet to find the product—usually without regard to geographic location—and has the product shipped, arriving often overnight. Certain Internet services allow the consumer to make a purchase offer to a large plurality of suppliers, any of which can accept, thereby forming a contract. Other services allow used products to be sold at virtual, worldwide auctions.

Surprisingly, these incredible advances have had little impact on the dining side of the restaurant business. Obviously, fast-food restaurants have been pioneers in the areas of food service automation. However, diners at sit-down style restaurants have nearly the same experiences as they did decades ago. With few exceptions, the largest noticeable difference from the point of view of the diner is that the average diner—having become accustomed to the e-speed of the Internet, lacks the patience of a diner from yesteryear. Similarly, as restaurants face problems of hiring employees, let alone hiring well qualified workers, many of today's wait staff lack the customer service skills which were commonplace in the past.

A close look at the typical dining experience reveals several instances where the diner may become frustrated with the service as a result of being in a position where the diner has to wait for the server to perform. Initially, a party arrives at a restaurant and has to wait to be seated. A host eventually seats the party and provides menus. Once seated, a bus person arrives and provides water to each of the diners. This bus person is usually not qualified or otherwise allowed to do much else. The party reviews the menu and waits until the server arrives to take drink orders. The party continues to look at the menus and waits until the server returns with drinks. Often, the server returns with the drinks so quickly that the party is not yet ready to order. In such a case, the server leaves and can often take too long to return. Conversely, the server may take too long to return with the drinks, or another server will return with the drinks and cannot take the various orders of the members of the party.

Once the orders are taken, the server leaves and the party has little to do but talk amongst themselves until the food arrives. Occasionally, new drinks are necessary in the interim so a party member must flag down the server or decide to wait until the food arrives to request another drink. After the food arrives, new drinks or other items such as ketchup and the like may be desired and, again, the party must wait for the server's further attention.

After the meal, the party waits for the server to return so that the bill may be requested. Sometimes, the server carries the bill in an apron so that it may be handed to the party immediately. Other times, it must be retrieved and updated to include additional beverages, such as the after dinner coffees. The server usually leaves after presenting the bill so that the party may divide the charges between themselves. However, especially in larger parties, the party may wish to receive separate bills in order to properly split the check. The party again waits for the server to return so that they may present some form of payment. If the party pays in cash, they may have to wait for the server to return with change. If a credit card is used, the party waits for the server to return with the receipt and signature slip.

Thus, there is a need to computerize or otherwise automate some of the functions of the wait staff of many restaurants to minimize the diner's wait time for service. As an additional benefit, such automation would relieve the busy server from certain job tasks.

Few attempts at dining automation have been attempted. One notable attempt at teaching the automation of sit-down style restaurants is provided in U.S. Pat. No. 5,845,263 to Camaisa, et al. (hereinafter “the '263 patent”). The '263 pertains generally to a portable interactive visual ordering system using wireless portable computers providing color images and other information about menu items to a customer. The customer can use the system to view the items, learn about the ingredients thereof, and place orders. Once the diner has eaten and is ready to leave, the ordering system may be used to enter payment information so that the diner may pay and leave without having to wait for the wait staff to arrive with the bill, return to accept payment, and return again to produce change or return a credit card.

Generally, however, the teachings of the '263 patent do not encompass a system which harnesses the truly awesome powers and potential of today's Internet and computer technologies. For example, the '263 patent presents information to the diner in a manner which can be somewhat puzzling to the diner having little computer experience. Though a help menu is provided, a user must leave the screen in which the confusion was encountered, go to the help menu, select an appropriate list of questions, find and memorize an answer, and return to the previous menu to apply what has hopefully been learned. It is foreseeable that a group of diners having difficulty using a computerized menu system may actually be delayed by such a system.

Additionally, little is envisioned in the way of providing a complete, enriched dining experience, ripe with entertainment, to the consumer. For example, a diner usually experiences a predictable yet significant delay between the time of placing an order and the time the food is brought to the table. This delay is largely due to the amount of time it takes to prepare the food. A group of people waiting for their orders may enjoy talking amongst themselves while enjoying appetizers. However, the solitary diner may have little to do to pass this time. A family with small children may welcome some form of entertainment to occupy the children until the food arrives.

The '263 patent teaches away from incorporating into a computerized menu system having wireless tableside computers, games and other forms of entertainment, the ability to “instant message” or send e-mail, and the ability to research entertainment options and pre-purchase tickets. However, the omission of such functions results in a failure to optimize the possible computerized, interactive dining experience. Today's computer generation will quickly identify these shortcomings and desire capabilities such as e-mail and games from a computerized system. Insofar as a computerized system is an attempt to lure customers to a restaurant, thereby making a restaurant more competitive in today's fast-paced economy, providing a limited computer system is akin to providing a menu without beverages. Computers are ideal platforms for providing endless forms of entertainment ranging from computer games to conversation forums to avenues for news and other media.

Another inconvenience which might be solved by a computerized restaurant system, and not addressed by any prior art reference, pertains to the difficulties in organizing a typical evening with friends. For example, often it is desired to meet friends for dinner and a movie. At some point, a restaurant must be selected as well as a particular movie, venue, and show time. It can be difficult to coordinate with all members of a party to decide on all of these selections, and be able to make a dinner reservation at the selected restaurant which allows adequate time to eat, travel to the theater, and get tickets before the movie is sold-out.

Yet another problem with the conventional restaurant routine is that it leaves little room to provide incentives for diners to become regularly returning customers. Many attempts with loyalty programs have been made but most of them are somewhat inefficient. Examples include stamp cards, club cards, coupons, and the like. These systems are inconvenient for the customer/patron because they require that the customer carry extra cards pertaining to various restaurants or remember to bring coupons with them while dining. Moreover, they do not allow for state-of-the-art marketing techniques, which personalize the marketing message to customers based on spending history or other demographics. The usual cards and coupons do not allow for such data-driven marketing.

The increased use of technology throughout society in general, and commercial use in particular, has increased both the consumer's comfort level and their expectations for technology. This system is designed to leverage technology to address customer and merchant needs not currently addressed using technology. The focus overall is on the customer experience; technology is merely the means to an end. The technology focus of the system will be threefold: simplicity, richness, and flexibility.

The simplicity of the system lies in both its ease of use, and its utilization of existing technologies in a unique milieu. The ease of use is achieved through a clean, rich user interface. The utilization of existing technologies such as HTTP, wireless LAN's, the browser metaphor and component-based development ensures simplicity in the development, support and deployment of the system, while remaining positioned to take advantage of emerging technologies such as PDA's and Web Phones.

The richness of the end-user experience is achieved through a graphical user interface utilizing intuitive screen layout, software assistance agents, tutorials and context-sensitive help, all augmented by appropriate animation and graphical elements. It is a customer-centric experience that encompasses and enhances the entire casual dining experience.

The flexibility of the system will allow the use of the system in varied and disparate environments. Wired or wireless LAN's can be utilized depending upon environmental and structural issues. Access via the Internet can be provided to customers based upon desired functionality (ex. customer-initiated reservations, access to loyalty program status, etc.). Integration of data from multiple systems can provide a basis for analysis of cross-chain trends. Interaction with PDA's and Web Phones can be accommodated as protocols stabilize and penetration of the market increases. And the ability to interface with multiple content providers allows for an experience tailored to the appropriate demographic target.

It can be seen that there is a need for a computerized menu system that reduces or eliminates some or all of the waiting steps encountered by diners in conventional sit-down style restaurants.

There is also a need for computerized dining system that is quick and easy to use, regardless of computer experience.

More specifically, there is a need for a computerized dining system which guides the user through the ordering process in a logical manner which leaves the diner with a feeling that the order has been properly entered and received by the restaurant staff.

There is also a need for a computerized menu system which provides various forms of entertainment to diners of all ages.

There is yet a further need for a computerized menu system which assists in the planning of an entire evening and allows some of the arrangements, such as movie and show time selection, and ticket purchasing, to occur during dinner as opposed to before or afterwards.

There is an additional need for a system which provides the flexibility to offer a variety of creative incentive programs in order to increase business and to reward frequent, repeat customers.

### SUMMARY OF THE INVENTION

The present invention pertains generally to a computerized system used at a table in a restaurant by customers thereof. The system presents an information center which can be used to present a wide variety of information to the customer and also allows the customer to convey orders to the restaurant and access other establishments for obtaining information and conducting business.

A few of the notable functions that the computer program provides to the customers of the restaurant include a food item ordering function which presents the various food items offered by the restaurant to the customer in a colorful, interactive manner. Preferably, color photographs and nutritional information, as well as preparation information, is provided. It is envisioned also that a video clip of a chef or wait staff, or even a celebrity, describing the dish, how it is prepared, how it tastes, and its nutritional information, is provided. Such a capability allows the computerized system to accurately describe the dishes to the restaurant patrons, bypassing the haphazard approach to presenting details by busy servers. In addition, the computer system can be easily programmed to present “specials of the day.”

A drink item ordering function is also provided which allows the customer to view a drink list and order beverages, alcoholic and otherwise, at anytime during the visit. This obviates the need to visit the bar or to summon a server of the wait staff.

A tag would be coupled with any food or drink order identifying the originator of the order so that the wait staff would be able to quickly and efficiently bring the desired items to the appropriate table. Such a feature will reduce the occurrence of items being delivered to the wrong tables, as is presently common at most restaurants.

It is preferable to provide a system which is connected to a network, such as the Internet. Internet connectivity would allow a customer to access the dining menu from a remote location so that a decision could be made, in advance, as to whether to dine at the restaurant and even what to order while there. The restaurant may use the preferred embodiments to allow customers to order take out food or have food ordered and nearly prepared, prior to arrival. Furthermore, it is envisioned that, at restaurants where reservations are required or encouraged, the system would allow a customer to view and select from a list of available reservation times online.

A payment function is provided that is extremely versatile. Preferably, information pertaining to a credit card or similar payment account is entered upon arrival and seating. This prevents restaurant losses due to diners who leave without paying their bills. This payment account does not necessarily have to be used to settle the final bill. In fact, it is preferred to provide the option of separate checks to each of the diners at a table. It would also be feasible to allow sub-groupings as would be the case of two couples dining together. Depending on the desires of the restaurant, payment could be done using credit cards, debit cards, checks, cash, or special accounts provided by the restaurant itself or similar associations such as a diner's club. In addition, in some embodiments, the system provides printers table-side to print receipts.

An employee summons function is provided allowing the diners to summon a server as may be necessary or desired for any reason. This provides an improvement over the present method of having to attract the attention of a server. Similarly, there could be a function wherein the presence of a manager could be requested or customer feedback can be entered.

It is also envisioned to provide job-specific summons functions. For example, if a diner spills a beverage, drops silverware, or needs another napkin, it may be more efficient to summon a bus person as opposed to summoning a server. Similarly, there may be instances when a diner would prefer the attention of a manager. This function prevents sending one employee to look for another employee.

A tutorial function is provided which can be used to demonstrate how to order food and navigate through the menu system, while actually ordering food and navigating through the menu system, as opposed to a teaching, learning, and then doing sequence which is more time consuming and can require repetition. The tutorial function is capable of generating an animated image on the color display which instructs the customer on appropriate use of the various functions by directing attention to appropriate areas on the display corresponding to the functions.

It is envisioned that a small animated figure will be present on the display in an area that does not obstruct the view of the various functions. Simply touching the figure would bring it to life and allow it to walk the customer through various functions. It is envisioned that a customer could drag the character over the function that requires further explanation whereby the character could verbally prompt the customer on how to navigate the system and order items or whatever the customer desires. Instead of giving examples, the tutor would actually be ordering items and performing functions which would, of course, be reversible in the event of an error. Preferably, the character would be related to the restaurant somehow and be humorous and friendly to use. The distinctive virtual personality afforded the animated character shall be one of the cornerstone attractions to the system of the present invention. Such a personality will turn the dining experience into entertainment.

If the customer is relatively experienced with the system and finds it more efficient to use the menu navigation function without the aid of the animated character, the tutorial function may be temporarily disabled, as described above, by simply touching the character or clicking on it, at which time the character will become smaller to take up less screen space, or disappear altogether.

As it would be advantageous to utilize a networked, computer system to provide as many services to a customer as possible, it is envisioned that an entertainment menu of non-food related functions is provided. The entertainment menu generally provides functions such as games, movie information, ticket purchasing, e-mail access, news information, all of which are described in more detail below.

A game function preferably provides any standard video game for children to play with while waiting for food to arrive. Additionally, it is envisioned that games for adults are provided as well. For instance, many sports bars and restaurants now provide nationwide trivia contests wherein a television screen displays typed out questions. Hand held answering devices are provided to the various tables at some or all of the restaurants in a particular chain nationwide. Scores are tallied to determine a nationwide winning team. An embodiment of the present invention could implement similar, and much more complicated and exciting games, on such a nationwide basis without having to produce special hardware to facilitate this friendly competition.

Similarly, it is envisioned to provide a function allowing tables to send messages to other tables. This would foster a social, interactive environment wherein people at tables could flirt or otherwise send messages to each other in a rather benign manner, as opposed to the rather outdated and pretentious practice of sending drinks over to another table. Insofar as the envisioned preferred embodiments are connected to a network, such as the Internet, it would also be possible to provide nationwide “chat rooms” wherein people could exchange opinions of the various menu items, thoughts about present events, sporting events, and the like.

Yet another function on the entertainment menu would preferably be a local events information function. Here, for instance, a customer would be able to determine which movies are playing in the area of the restaurant, find out the show times, view the ticket availability, and even purchase tickets to the show. Preferably a printer is provided at each table, capable of printing the tickets out so the customers would be able to bypass any lines present upon arrival to the theater. This function also applies to other events such as plays, sporting events, concerts and the like.

A big advantage of this local events information function pertains to the logistic simplicity it brings to organizing an evening. No longer does a person have to assume a coordinator role, making numerous phone calls to all members of the party, to figure out which event everyone would like to see and whether it is possible to squeeze dinner into the schedule. A party can simply agree to meet at a specified restaurant at a given time, sit down, order food, and begin planning the remainder of the evening while waiting for the food to arrive. Face to face communication efficiently leads to the selection of an available event at a local venue. Tickets are purchased immediately and the meal may be enjoyed without having to worry about the event selling out. No member of the party would be required to go to the ticket window before dinner to buy tickets to popular events which typically sell out. Moreover, time for standing in the ticket line does not have to be factored into the planned departure from the restaurant.

Another function that is envisioned is a human resources function. A human resources function would allow a customer to learn about hiring opportunities at the restaurant or at nearby restaurants in the same chain. Preferably, an electronic application could be filled out. Additionally, the applicant could select from a plurality of interview times, obviating the need for the hiring manager to contact the applicant before the interview. Additionally, the human resources function could provide a suggestion box or a complaint form for customers to express their opinions of the restaurant or bring complaints to the attention of the manager in a discreet, confidential manner. This system streamlines the functions performed by the human resources department of a restaurant, allowing it to become almost paperless. Through the system, employees can be trained, forms (such as a W-4 form) can be generated, completed, and filed.

The versatility of the present invention further allows selected interface units, wireless or otherwise, to be programmed for limited, or more specialized uses. For example, it is envisioned that bars and restaurants implementing the preferred embodiments of the present invention, provide a kiosk at a predetermined location inside the establishment, from which customers could select and summons a taxi service. It is further envisioned to provide this kiosk with a payment account input capability, and a destination address input function, such that it is possible to prepay for the taxi service using any desired account, such that a cash exchange with the taxi driver is not necessary upon arrival at a destination. This embodiment would be especially advantageous in the event that a customer has too much alcohol and requires a ride home.

It is thus an object of the invention to provide a system for the automation of many of the functions performed by wait staff of a sit down style dining establishment.

It is also an object of the invention to provides a computerized restaurant ordering system having a plurality of portable, wireless remote interface units capable of communicating with a central processing unit.

It is further an object of the invention to provide an automated method of ordering drinks and food at a sit down style restaurant which is easy to use by customers who have little to no computer experience.

Another object of the invention is to provide an automated method of method of ordering drinks and food which includes providing an animated computer image which asks simple questions and acts on the answers thereto to assist a customer in the navigation and use of the various functions provided by an automated menu system.

Still another object of the present invention is to provide a computerized menu providing access to a network having information about local entertainment and further allows a customer to purchase tickets to various local events.

Yet another object of the present invention is to provide a computerized method for ordering food and beverages from a family style restaurant whereby a customer is able to establish an electronic payment account, accessible by a computerized system facilitating this method, which allows a customer to pay for food and beverages, buy gift certificates which can be delivered via e-mail or printed from a printer, and provides information to the restaurant so that the restaurant may give rewards and incentives to the customer.

It is yet another object of the present invention to provide a computerized menu/ordering system which is customizable to fit the needs of various restaurants. More importantly, the present invention will provide a system which is customizable to fit the needs of various patrons. For example, using voice recognition and voice synthesis modules, the system can be easily operated by the blind or with limited sight. The visual and aural aspects of the system can also be developed to support multi-lingual capability so that a person who speaks and reads only German could just as readily order a meal as a person who knows English.

Another object of the invention is to turn the dining experience into an entertainment experience. Through the use of highly evolved animated virtual servers, the system becomes addictively entertaining and useful—suggesting drinks, singing happy birthday to patrons, and being ever available to assist customers.

These and further objects and advantages of the present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 is a representation of the opening screen for the user interface of the present invention.

FIGS. 2 and 3 are representations of the portion of the user interface by which food and drink orders are placed.

FIGS. 4 through 6 are representations of a portion of the user interface by which a customer's bill is paid.

FIG. 7 is a representation of a portion of the user interface by which offers a customer entertainment features.

FIG. 8 is a representation of a portion of the user interface by which allows the research of movies.

FIG. 9 is a representation of a portion of the user interface assisting with the purchase of gift certificates.

FIG. 10 is a representation of a portion of the user interface by which messaging can be sent and received.

FIG. 11 is a block diagram showing the access units connected to a network.

FIG. 12 is a block diagram of one embodiment of the present invention.

### DETAILED DESCRIPTION OF PREFERRED EMBODIMENTS

While there have been computer-based systems disclosed in the art for use in restaurants by customers, such systems have been rudimentary. As a result, such systems have not met with commercial success. The present invention provides an enhanced computerized restaurant system that is customer-centric and which offers a plethora of functions which result in an increased level of satisfaction with the dining experience.

One skilled in the art is capable of setting up a computer system in which tables of a restaurant, as well as the kitchen, the host area, the bar, and the like, are equipped with access units 1105 networked together and which are equipped with software 1110 to present the users of the system with a user interface offering various functions. The access units can be personal computers with a CPU, a display screen and an input device, such as a keyboard, mouse, or touch sensitive screen. Or, the access units could be PDAs such as a Palm manufactured by 3Com or a Visor by Handspring. In other embodiments, the access units could be thin Internet appliances which are economical to produce and offer only the necessary components. Of course, the system could be a mixture of various types of access units. For example, the restaurant tables could be outfitted with Internet appliances, the host area could have a PC with a touch-sensitive screen and the waiters could be equipped with hand held wireless PDAs.

Those skilled in the art can readily network such access units together. The access units could be interconnected with USB, FireWire, SCSI or other type of interface. A LAN, WAN, Intranet, or the Internet 1115 can all function as the network across which the access units 1105 can communicate.

The user interface presented to the various users can be implemented through any computer language. For example, Visual Basic, Java, C++, and the like can all be used. HTTP or another protocol can be used to transmit information from the various access units.

The access units can be supplemented with one or more servers which offer various functions. For example, a web server could offer Internet access, a file server could be used to distribute and store data files, and a print server could schedule and maintain the printing of bills, receipts, tickets, and the like.

While all of the above can be configured by one skilled in the art, the novelty of the present invention includes the functionality provided over such a networked system. In the prior art, customers' needs have not be well met. Some elementary restaurant computer systems allow waiters to maintain bills for their various tables of patrons. Other systems have allowed customers to view photos of the offered meals—basically just an electronic menu. The present invention places the customer's needs in the center. Thus, this customer-centric system's goal is to provide customers with an outstanding dining experience by offering advanced electronic ordering alongside numerous entertainment possibilities.

The various enhanced functions provided by the present invention will now be addressed individually. One skilled in the art will realize that an embodiment of the invention can include all of these functions or a subset thereof. In the following description, it is assumed that the access unit at a customer's table is a PDA or a PC with a touch sensitive screen enabling the user to simply touch a series of icons or buttons to operate the invention. Of course other types of input devices can also be used.

Beginning a Dining Experience

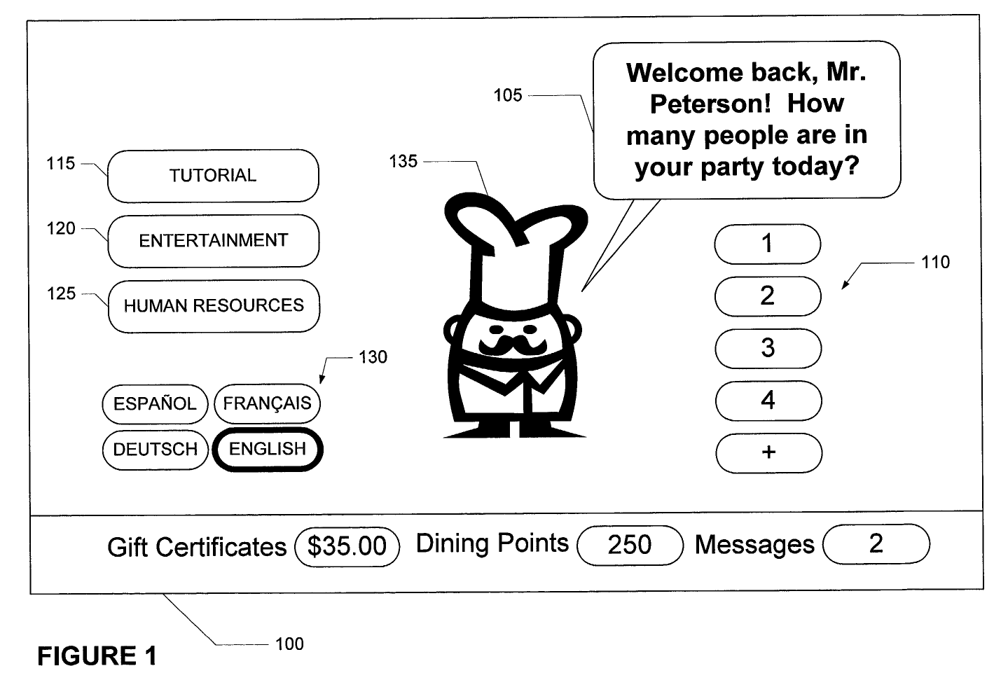

In a restaurant equipped with the present invention, dining patrons have an access unit at their table. FIG. 1 shows how the opening screen of the present invention 100 is configured in one embodiment. The dining experience begins by the customer entering an account number, a credit card number (which can be read by a credit card unit at the table), a loyalty program card or ID, a phone number, a name, etc. In a preferred embodiment, the customer also enters the number of people at the table so that the system can interact with the table correctly. Note in FIG. 1 that the client has already logged onto the system as the system has greeted him as “Mr. Peterson” 105. The screen has a series of buttons for the number of people in the party 110, as well as buttons for a tutorial 115, entertainment services 120, and human resource services 125. In this embodiment, buttons are also provided to instruct the system to use various languages 130.

Of special note is the character included in FIG. 1 as element 135. This cartoon character is a ‘virtual server’ which is animated and may interact with the customer through cartoon balloons or voice synthesis. The virtual server 135 assists users in operating the system, offers suggestions, and personalizes the dining experience. The virtual server 135 can be an effective sales device when it is programmed to suggestively sell, or upsell, to the diners. For example, once the main course arrives at the time, the virtual server 135 can wait a period of time and then suggest dessert or coffee. Or, during the ordering process, the virtual server could recommend appropriate wines, etc.

Food and Drink Ordering

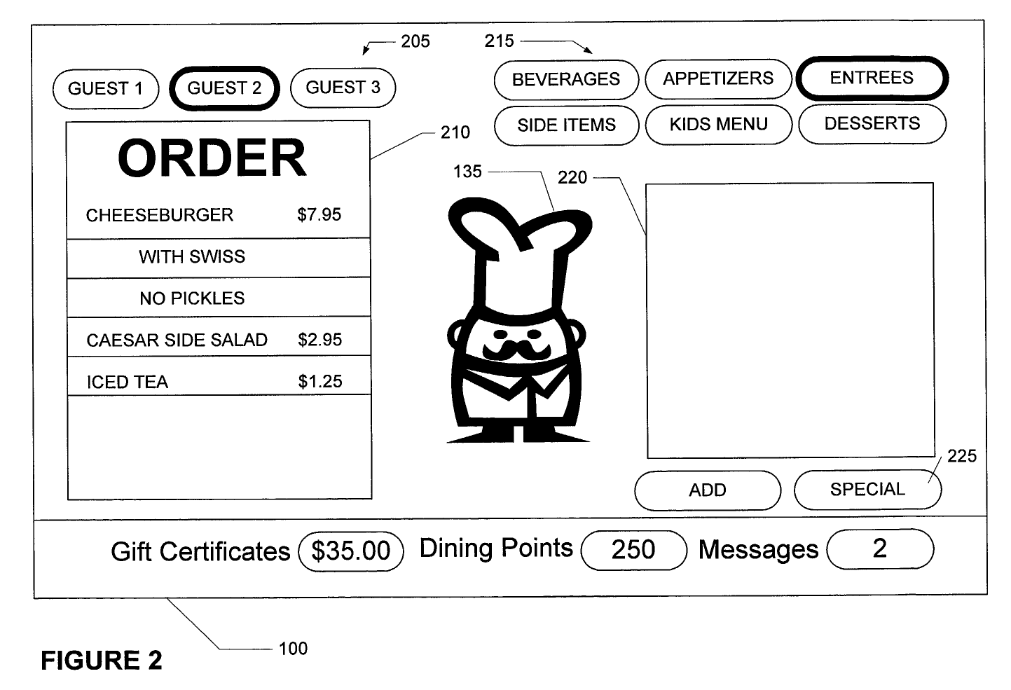

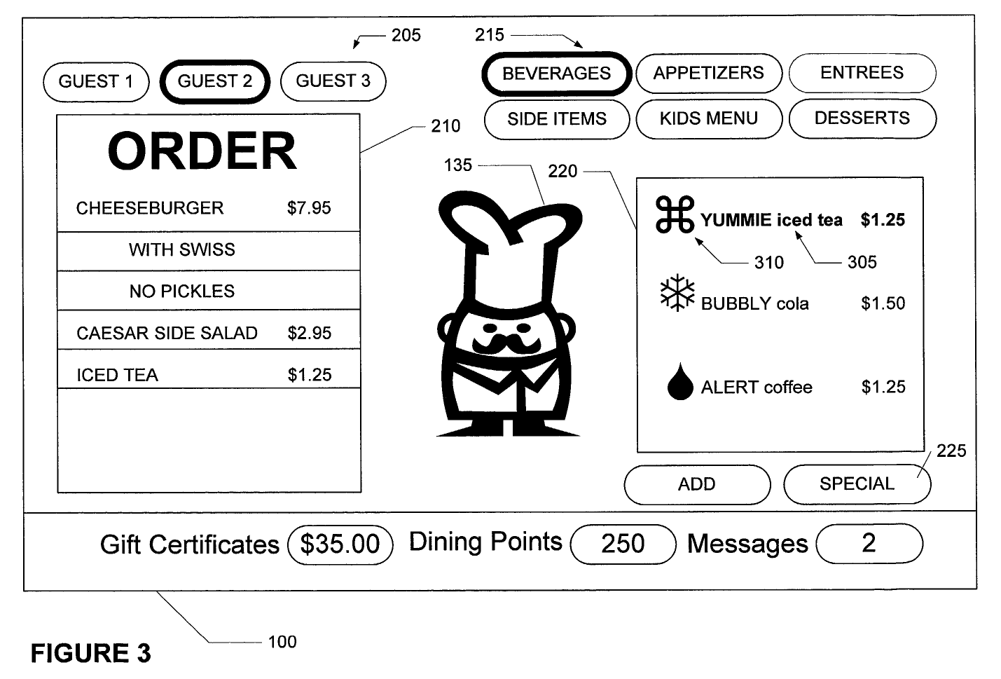

FIGS. 2 and 3 illustrate one version of the invention in which food and drinks are ordered by the customer while seated at his or her table. In FIG. 2, the virtual server 135 is again present, assisting the customer in placing the order. A series of customer-identifying buttons 205 allow the various elements of the order to be associated with the various guests at the table. An order tablet region 210 presents the order to the user through an everyday metaphor of a restaurant order tablet. The various portions of the menu are accessed via section buttons 215, such as “beverages,” “appetizers,” and “kids menu.” By pressing the “entrees” section button 215, a list of the entrees appears in the information region 220 of the screen. Once a customer selects one of the entrees, the information region 220 is also used to display photographs, nutritional information, descriptive text, and the like. Of course, everyone has preferences on how food is cooked (e.g., rare, medium, well done) and what condiments are added or removed from the order (e.g., sliced onions, tomatoes, mustard). Thus, a special order button 225 is available for the customer to specify such requests.

FIG. 3 is one embodiment of the beverages screen, which is accessed when the customer presses the “beverages” section button 215. In this screen, a customer can identify her beverage by name 305 or trademark logo 310. Such logos offer a licensing feature in which the restaurant may earn licensing fees by displaying a manufacturer's logo.

FIGS. 2 and 3 offer customers seated at a table to place a food and beverage order at anytime. This allows diners in a rush to order quickly without needing to wait for a waiter to appear, while allowing diners who prefer to browse the menu, the comfort of not being interrupted by an impatient waiter.

Paying the Bill

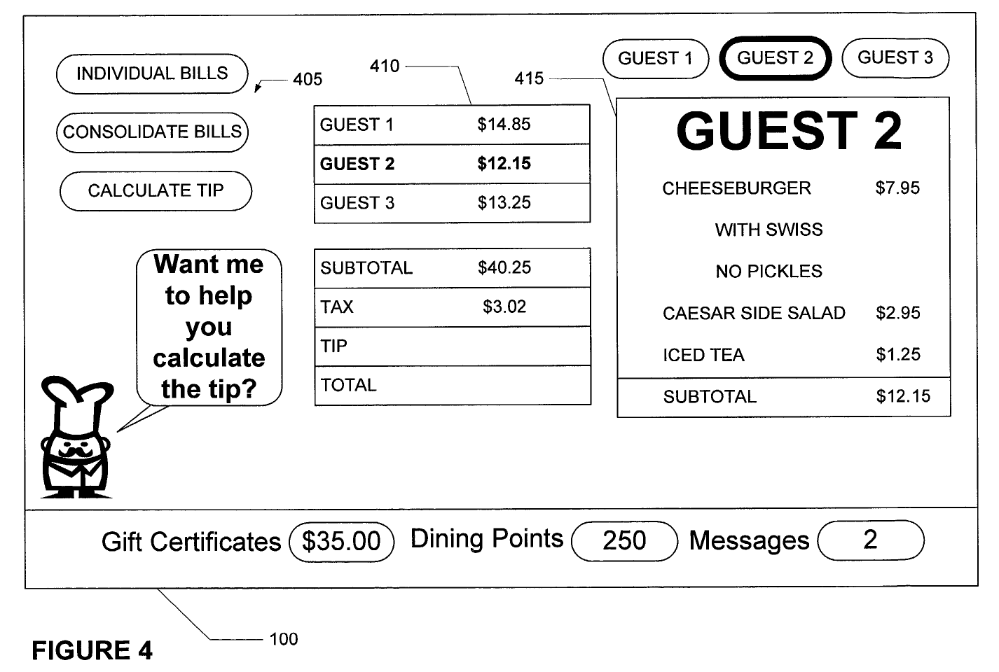

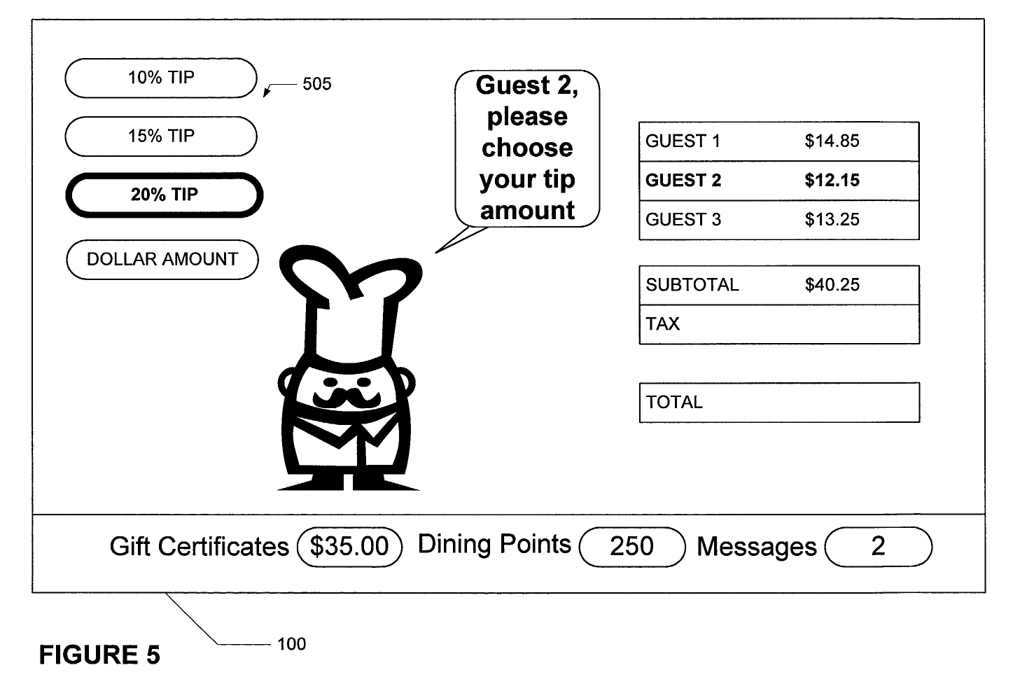

FIGS. 4 through 6 illustrate how the present invention allows a table's bill to be paid. In FIG. 4, the billing screen includes a series of payment buttons 405 which allow the table to decide to pay individually, as couples, as a group, or any similar variation. Each customer's total is displayed 410 and details for the customer can be viewed 415. FIG. 5 shows a tip calculator function which presents the interested customer with a series of tipping option buttons 505. By pressing a tipping option button 505, the tip is calculated and added to an individual's bill. This feature can alleviate the problem diner's often have in calculating the tip without the use of a calculator. In addition, it encourages customers to tip, increasing the take-home pay of the waiters.

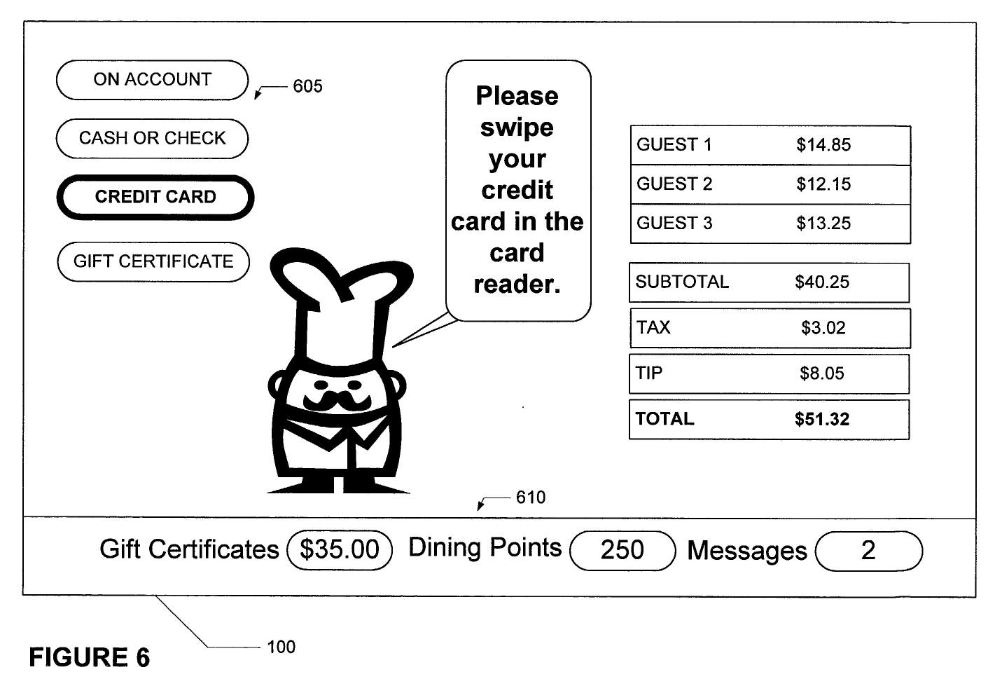

FIG. 6 presents a customer with a series of payment option buttons 605, such as “credit card,” “cash,” and “restaurant account.” A restaurant account can be pre-paid or pre-authorized so that customers can dine and use the account like an automatic tab or so their meals are periodically billed to their account. Credit and debit cards can be swiped through a reader which is situated at the table, thus ensuring that the customer does not need to wait to have a waiter take the card to be authorized and later returned with a receipt. In some embodiments, the receipt is sent via e-mail to the customer, while in other embodiments, a nearby printer prints the receipt for the customer.

Loyalty Programs

FIG. 6 also includes a loyalty program region 610 which can notify the customer of the number of points accumulated in a loyalty program. Such points can be redeemed for food items. A common problem with loyalty programs is that customers often must keep track of program cards. While some embodiments of the present invention allow a loyalty card to be swiped at the access unit, other embodiments search a loyalty program database when the customer enters her name or her credit card information. In this way, a loyalty program can be used without requiring loyalty cards. The ease of such a program—in which customers earn points without any additional work—increases the success of such a program.

Remote Functionality

Of course, as the access units are basically computers and the network connecting them may be an intranet or the Internet, it is within the scope of the present invention to extend its functions to the customer at her home or work. For example, a customer could access the system from a remote location via a website (such as from work or from their homes) and view the specials of the day, and determine whether certain dishes are available, all before entering the restaurant. For the rushed customer, the food order can be entered over the Internet so that the food is ready shortly after arriving at the restaurant—or even ready for pick-up or delivery. Alternatively, the customer could make a reservation over the Internet.

Quick Assistance

A common frustration by restaurant diners is attempting to find one's waiter during the course of the meal. Sometimes food is not prepared satisfactorily and must be returned. Sometimes a fork has been dropped and a clean one is needed. In traditional restaurants, getting the waiter's attention can take some effort. However, the present invention enables the customer to electronically summon the waiter at any time. In addition, the invention can be configured so that the proper person—whether it be he manager, the waiter, the host, etc.—is requested.

Entertainment

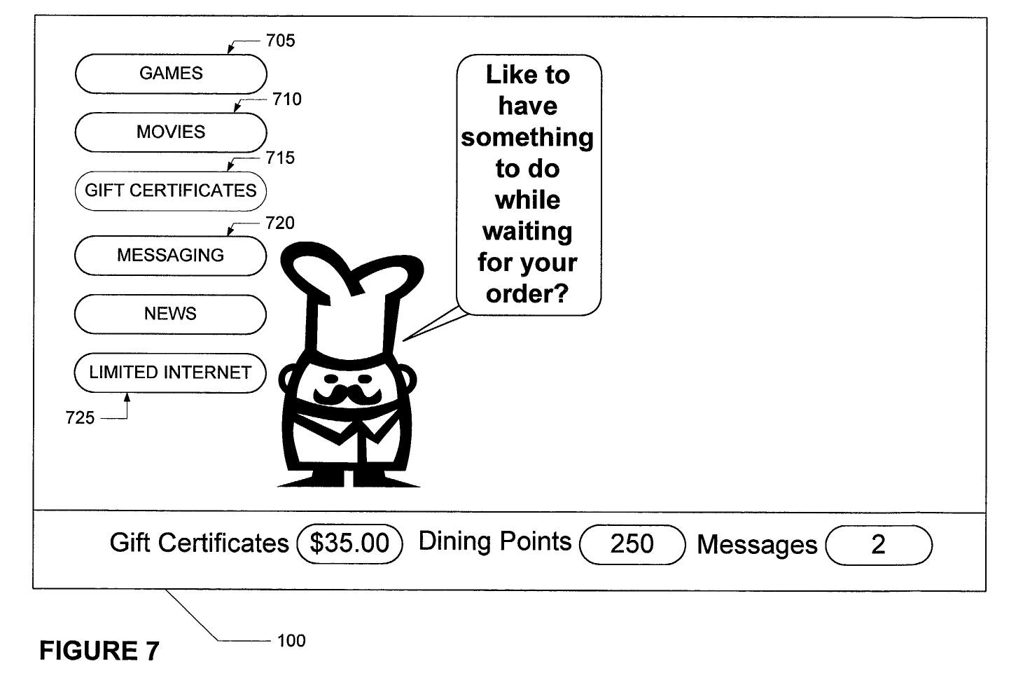

FIG. 7 shows the present invention's inclusion of a number of Entertainment options. In FIG. 7 there are a series of buttons which a customer can use to play games 705, find out information about movies 710, order gift certificates 715, access messaging 720, news and limited Internet access 725, etc.

Games 705

It is well known in the art to provide arcade style games at a restaurant. The present invention incorporates video games, quiz games and the like into the access unit enabling children to play at the table rather than venturing to the video games unattended. The games provided by the present invention can be configured so that the guests at a table can play against one another, as teams, or can play with guests from other tables or other restaurants, such as is done with interactive trivia games in standalone systems. The present invention has the advantages of not requiring extra equipment at the table, and awarding loyalty program points, or discounted/free food or drinks as prizes for the games.

Movies and Tickets 710

A recent trend since the late 1990s has been the emergence of super-sized theater complexes offering perhaps 20 movie screens. When a group of friends plans a night out, sometimes they wish to go to dinner and a movie. However, planning such a night entails numerous phone calls and e-mail messages as the friends decide on which movie to see, which theater to see the movie at, and at which time to go. The present invention vastly improves this process.

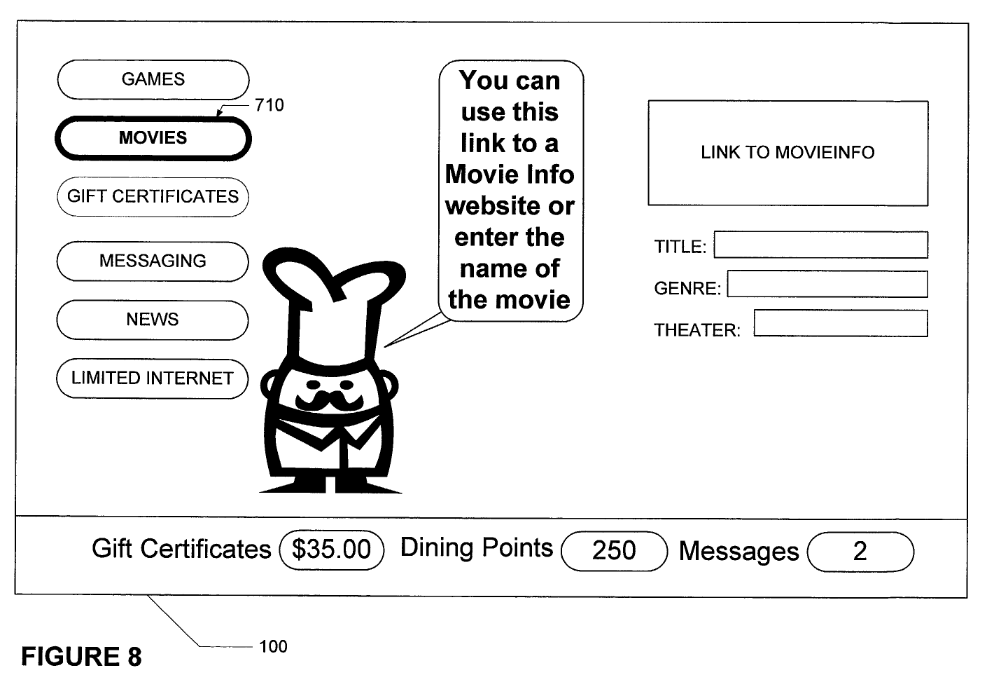

FIG. 8 shows one screen from the present invention in which the customers at a table can find out information about various movies from a database of movie reviews. Such a database can be stored on the restaurant's file server, or can be accessed over the Internet. The system can also be used to then search local theaters to find where the movie is playing and at what time. The system can automatically return with shows that are scheduled to begin within the next hour or two so that the customers can readily narrow their choices. In addition, the system can also order and pay for the movie tickets from the access unit so that the customers do not need to worry about arriving at the theater early enough in case of it being sold out.

Gift Certificates 715

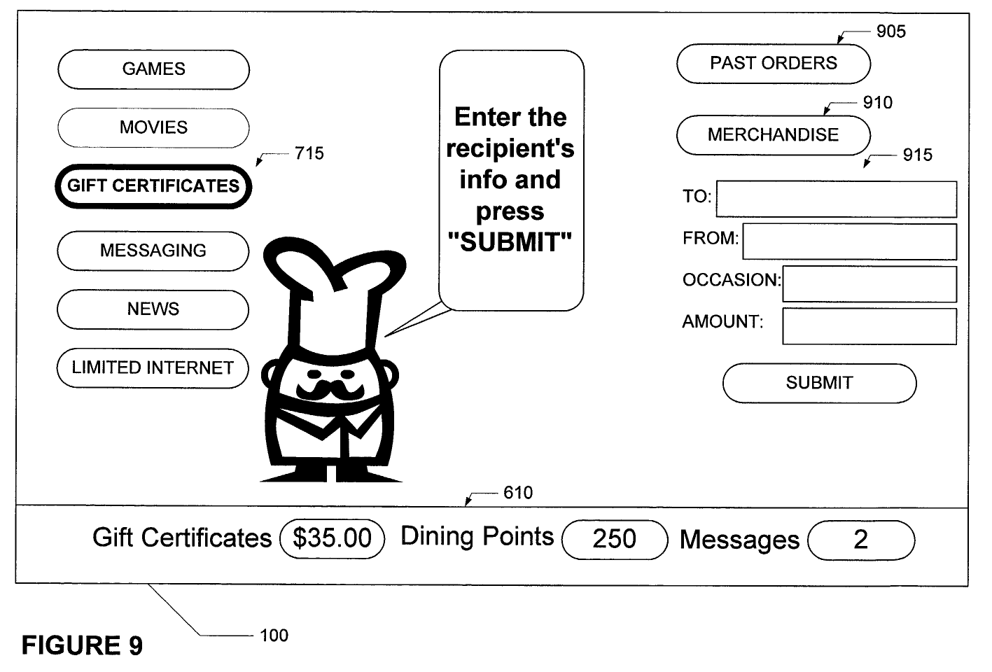

FIG. 9 illustrates how the present invention allows a customer to order gift certificates and other merchandise from the access unit (or over the Internet). In FIG. 9, buttons are available for viewing past orders 905, checking merchandise that can be purchased 910, or buying a gift certificate 915. Through this screen, the program loyalty points are displayed 610, which can be applied towards gift certificates or other merchandise. The gift certificates 915 can be e-mailed to the recipient, or printed from a printer.

Messaging 720

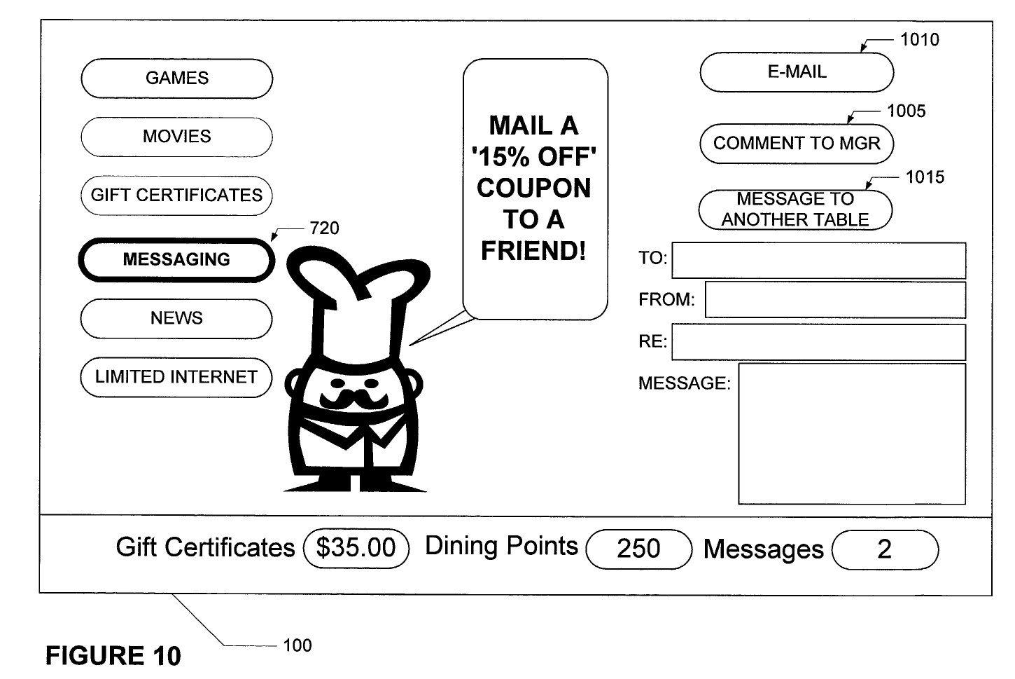

FIG. 10 illustrates how the present invention provides various messaging modes to the customer. Buttons are provided which allow the customer to send a message to the management staff 1005 (in order to submit a suggestion or other comment) or to e-mail friends 1010 free of charge. Such e-mail messages can be embedded with restaurant information, including coupon offers or information on current specials. In this way, the “free” e-mail becomes an advertisement tool. From the screen of FIG. 10, customers can also contact customers at other tables 1015 either via e-mail or instant chat.

News and Limited Internet Access 725

A sports bar is a common establishment in most regions. The present invention enables customers to access news and sports information on demand from their access units. While cyber-cafes have allowed customers to pay for Internet access, the present invention can also be configured to provide Internet access, or limited Internet access. For example, perhaps the present invention will only allow access to CNN.com, ESPN.com, and Time.com. In this manner the present invention ensures that improper websites are not accessed, and can also cross-license with the owners of the available websites.

Human Resources and Restaurant Management

While the above functions have been addressed to the customer of a restaurant, the access units can also be utilized of course for other purposes. For example, the host area can use an access unit to track which tables are available for new customers, while the orders placed by customers appear on access units in the kitchen or beverage center. In addition, the access units and their user interfaces can be used to facilitate common human resource tasks. For example, people can enter job applications through the use of the user interface. Performance reviews of the waiters and cooks can be entered as well. Available jobs can be listed and store locations can be shown. Clearly, all types of information can be displayed and/or collected by such access units.

Restaurant managers can use the present invention to maximize sales. By using data mining software, the management team can identify dining trends, such as which days of the week frozen desserts are sold the most. Such knowledge allows the managers to more accurately predict the amount of food needed in a given period, etc. Such data mining can also be used to target specific customers, based on their dining history. For example, discounts or coupons can be individually distributed to customers most likely to respond to such offers.

Other Features

The present invention includes various other features, including the use of scent technology to provide sensory menus. Digital scent technology is in development by companies such as DigiScents. In one embodiment of the present invention, a peripheral unit is attached to the table-side units. The peripheral unit allows various scents to be generated upon demand. Thus, the table-side units can entice restaurant patrons with sensory menus of the food items, etc.

In another embodiment, a wireless taxi/limo service is provided. This functionality allows a restaurant patron to summon a cab so that it will be waiting when the dining party is finished. The cab can transport the party to their next entertainment stop (such a movie), or it can deliver the party to their homes. This is an especially attractive feature for diners who wish to drink during dinner but do not want to drive home afterwards.

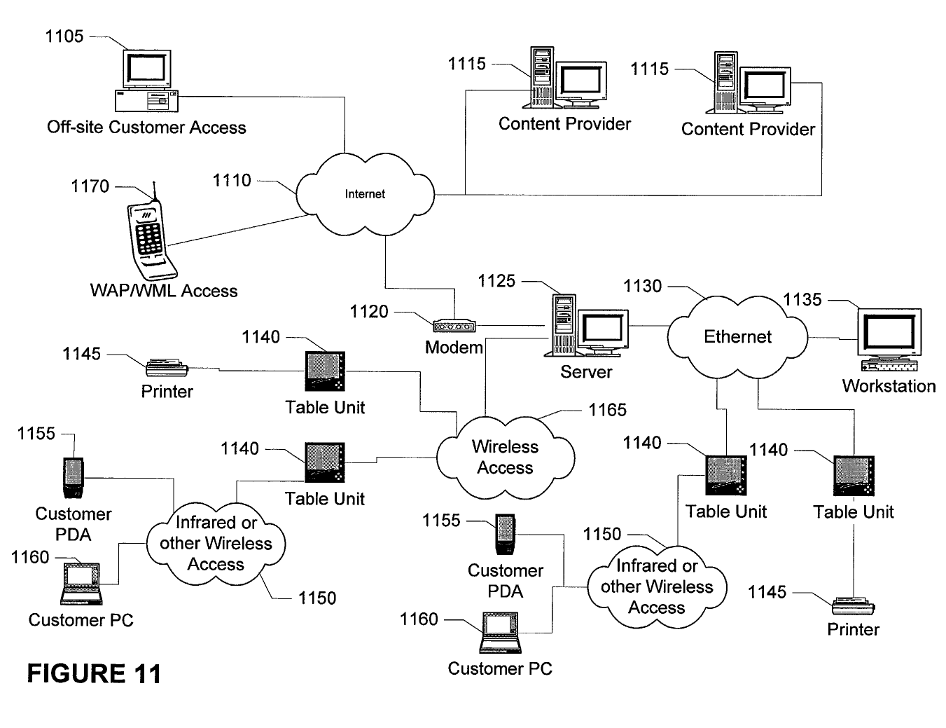

FIG. 11 is a block diagram of one technical architecture which can support the present invention. FIG. 11 shows an application server 1125 which supports several clients. One type of client is a workstation 1135 which is used by the restaurant manager, hostess, etc. Other clients are table units 1140 which are usable by the restaurant patrons to place orders, find information about movies, apply for restaurant jobs, etc. In some embodiments, a printers 1145 can be made available so that the restaurant patron can print receipts, coupons, movie tickets, and the like. These workstations 1135 and table units 1140 can be in communication with the server 1125 via a network, which in one embodiment is an ethernet connection 1130. In some embodiments, the restaurant patrons can also use their own PDA 1155 or laptop 1160 to communicate to the table units 1140. In such an embodiment, the laptop and PDA can use infrared or other wireless technology.

Of course, the server can be accessed by means other than an ethernet 1130. For example, the server 1125 can be adapted to interact by radio, infrared, or other wireless means 1165. For example, table units 1140 can use radio frequencies. And these wireless table units 1140 can also be accessed by patrons with their PDAs 1155 or laptop PCs 1160.

In one embodiment shown in FIG. 11, the server 1125 includes a modem 1120, such as a DSL modem to allow broadband access to the Internet 1110 or other network. Over this network 1110, customers can use their home or work PCs 11 05 to access the server 1125 to make reservations, preview the menu, check the status of the restaurant's loyalty program, etc. The server 1125 can access various content providers 1115 in the process of providing customers with information on movies, concerts, movie reviews, and the like.

In one embodiment of the structure illustrated in FIG. 11, the server 1125 can be a Compaq, IBM, or similar brand computer server which uses Windows 2000, Windows XP, Unix, Linux, or other operating system. The workstations 1135, table units 1140, customer PCs 1160 can be any of a number of available computers, such as those available from Apple, Compaq, IBM, Dell, Micron, and the like. The PDA 1155 can be a Palm Pilot, a Handspring Visor, etc. Off-site customers can also access the system through their cell phones 1170 through the use of WAP/WML (i.e., wireless application protocol/wireless markup language). Through this access method, the patron's phone behaves like an Internet browser.

One skilled in the art can readily build a system such as shown in FIG. 11 from components available on the market. Of course, some restaurants may choose to use specialized table units 1140 which may be integrated with the restaurant tables, have touch sensitive screens, voice recognition, and other advanced capabilities.

The system shown in FIG. 11 includes a wide variety of software interfaced to provide the requisite functionality. In one embodiment, much of the interactions from the server 1125 to the table units 1140, customer PDAs 1155 and customer PCs 1160 is accomplished through a custom developed program written in HTML or using ASP, Visual Basic, Java, another high-level computer language, or a combination of these. The attached computer program listing appendix containing computer source code shows one embodiment of such computer source code. Clearly, the system can be produced using interfaces to third-party software modules. For example, in one embodiment, there is an interface to one of the currently available third-party back-office systems. Other interfaces can pull various forms of content from the Content providers 1115. For example, content may be available as a series of web pages in HTML or a series of PDF-format files.

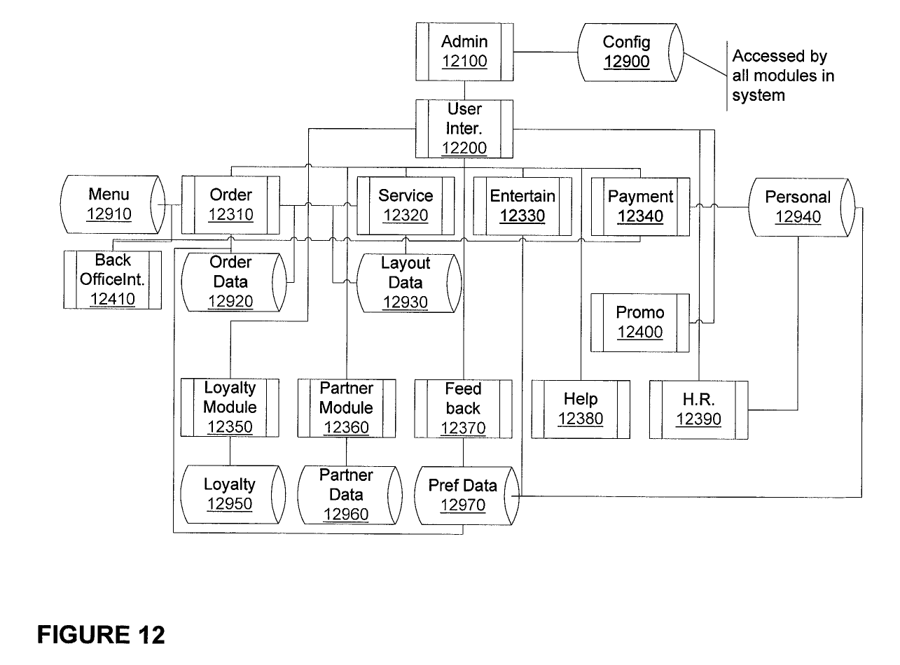

As shown in CD-ROM appendix, and as illustrated in FIG. 12, there are a number of modules or subroutines which interact. FIG. 12 shows a block diagram of one embodiment of the present invention. In FIG. 12, an Administration Module 12100 acts as the system's control center, managing Configuration Data 12900—such as user ids, passwords, defaults, file locations, etc.—which can be accessed by all modules in the system. The Table Side Interface Module 12200 presents the in-restaurant user interface (menu, graphics, touch screen functionality) to all of the system's functions provided by the other modules, as well as specialized forms for workstations (host/reservations/server/takeout).

The Order Module 12310 processes orders initiated in-restaurant by the user from the Tableside User Interface Module 12200, as well as from workstations and remote user (Internet, web phone, PDA) access. The Order Module 12310 controls creation of orders based on information contained in Restaurant Menu Data 12910 and assigns the order to appropriate service personnel via the Service Module 12320, storing the order information in the Restaurant Order Data 12920 and passing the order information to any external back-office restaurant system via the BackOffice Interface Module 12410. Preference information from the user's order (ex. Special sauce, no ice, At low fat dressing) is saved in Personalization/Preference Data 12970.

The Service Module 12320 assigns and communicates service requirements and monitor performance based upon information in the Restaurant Staff/Layout Data 12930 when an order or service request is initiated by the user from the Tableside User Interface Module 12200, from a workstation, or by the system itself. Information necessary to complete the service request (ex. Coffee refill, food preparation issue, etc.) is provided to the Service Module 12320 by the initiating entity and passed on to the appropriate service personnel and/or workstation.

The Entertainment Module 12330 provides access from the Tableside User Interface Module 12200 to entertainment options for the user (ex. Puzzles, quizzes, Internet access), tailoring entertainment content presentation based upon the user's historical preference information stored in Personalization/Preference Data 12970.

The Payment Module 12340 allows bill generation and total or divided payment and receipt printing from the Tableside User Interface Module 12200, as well as from workstations and remote user (Internet, web phone, PDA) access. Credit card data obtained via user swipe, as well as information from the Diner Personal Data 12940—credit card information, prepaid account, etc.—and the Loyalty Program Data 12950 is used to apply discounts and complete the payment transaction(s). Information relating to the payment transaction(s) are passed to any external back-office restaurant system via the BackOffice Interface Module 12410.

The Promotion/Certificate Module 12400 provides promotional announcements, special offers, coupons and gift certificates orders initiated in-restaurant by the user from the Tableside User Interface Module 12200, as well as from workstations and remote user (Internet, web phone, PDA) access.

The Loyalty Program Module 12350 provides information related to the user's loyalty program status (ex. points earned, level, expiration dates) and general loyalty program information when initiated in-restaurant by the user from the Tableside User Interface Module 12200, as well as from workstations and remote user (Internet, web phone, PDA) access based on information contained in Loyalty Program Data 12950.

The Partner/Affinity Module 12360 provides access to business partner services (ex. Delivered takeout food, taxi service) as well as services with an affinity to the dining experience (ex. Ticketmaster for concert tickets, General Cinema movie Tickets, other marketing tie-ins) when initiated in-restaurant by the user from the Tableside User Interface Module 12200 based on information contained in Affinity/Partner Data 12960.

The Survey/Feedback Module 12370 allows the user to take targeted surveys (ex. by demographic, by customer loyalty status, etc.) or provide feedback on food, service, or the system when initiated in-restaurant from the Tableside User Interface Module 12200 based on information contained in Personalization/Preference Data 12970. The Survey/Feedback Module 12360 also provides untargeted surveys to remote users (Internet, web phone, PDA).

The Human Resources Module 12390 allows the user to view information about employment opportunities and benefits, chain location information, and apply online when initiated in-restaurant from the Tableside User Interface Module 12200 or remotely via the Internet. Information related to applications are stored in Diner Personal Data 12940.

The Agent/Help Tutorial Module 12380 helps guide the user through the system when initiated in-restaurant from the Tableside User Interface Module 12200. There is classic help support, a tutorial describing the system, its functionality and features, and an agent based support system that guides the user and can be used in either a “practice” or “live order” mode.

Those skilled in the art will further appreciate that the present invention may be embodied in other specific forms without departing from the spirit or central attributes thereof. In that the foregoing description of the present invention discloses only exemplary embodiments thereof, it is to be understood that other variations are contemplated as being within the scope of the present invention. Accordingly, the present invention is not limited in the particular embodiments which have been described in detail therein. Rather, reference should be made to the appended claims as indicative of the scope and content of the present invention.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A computer code embodied on a computer readable medium for a customer-centric restaurant communication system, comprising:
a code segment that provides a user interface that allows a restaurant diner to order food and drinks without interaction with a human server;
a code segment that provides a virtual server as part of the user interface, for assisting the restaurant diner with the user interface;
a code segment that provides bill payment functionality to allow the restaurant diner to pay for the food and drinks with cash, a check, credit card, or a gift certificate; and
a code segment that provides entertainment services to occupy the attention of the restaurant diner.

2. The computer code embodied on a computer readable medium for a customer-centric restaurant communication system from claim 1, wherein the entertainment service is movie information access.

3. The computer code embodied on a computer readable medium for a customer-centric restaurant communication system from claim 1, wherein the entertainment service is a game.

4. The computer code embodied on a computer readable medium for a customer-centric restaurant communication system from claim 1, wherein the entertainment service is Internet access for browsing websites.

5. The computer code embodied on a computer readable medium for a customer-centric restaurant communication system from claim 1, wherein the entertainment service is Internet access in which browsing is limited to a predetermined set of websites.

6. The computer code embodied on a computer readable medium for a customer-centric restaurant communication system from claim 1, further comprising a code segment that allows the restaurant diner to send Internet e-mail messages.

7. The computer code embodied on a computer readable medium for a customer-centric restaurant communication system from claim 1, further comprising a code segment that allows the restaurant diner to send messages to a second restaurant diner also using the restaurant communication system.

8. The computer code embodied on a computer readable medium for a customer-centric restaurant communication system from claim 1, further comprising a code segment that provides a data mining analysis tool for analyzing transactions performed by the restaurant communication system.

9. The computer code embodied on a computer readable medium for a customer-centric restaurant communication system from claim 1, further comprising a code is segment that allows the restaurant diner to purchase restaurant gift certificates.

10. The computer code embodied on a computer readable medium for a customer-centric restaurant communication system from claim 1, further comprising a code segment that allows the restaurant diner to place an order from a remote location via the Internet.

11. The computer code embodied on a computer readable medium for a customer-centric restaurant communication system from claim 1, further comprising a code segment that manages an incentive program to encourage the restaurant diner to order the food and the drinks.

12. The computer code embodied on a computer readable medium for a customer-centric restaurant communication system from claim 1, further comprising a code segment that provides integrated human resource capabilities for a restaurant.

13. The computer code embodied on a computer readable medium for a customer-centric restaurant communication system from claim 1, further comprising a code segment that performs voice recognition and voice synthesis to allow the restaurant diner to operate the restaurant communication system even if disabled.

14. The computer code embodied on a computer readable medium for a customer-centric restaurant communication system from claim 1, wherein the virtual server is an animated figure that emulates human personality traits.

15. The computer code embodied on a computer readable medium for a customer-centric restaurant communication system from claim 1, wherein the virtual server teaches the restaurant diner how to operate the restaurant communication system.

16. The computer code embodied on a computer readable medium for a customer-centric restaurant communication system from claim 1, wherein the virtual server suggestively sells the food and the drinks to the restaurant diner.

17. The computer code embodied on a computer readable medium for a customer-centric restaurant communication system from claim 1, further comprising a code segment that allows the restaurant diner to make a restaurant reservation via the Internet.

18. A computer code embodied on a computer readable medium for a customer-centric restaurant communication system, comprising:
a code segment that provides a user interface that allows a restaurant diner to order food and drinks without interaction with a human server;
a code segment that provides a virtual server as part of the user interface, for assisting the restaurant diner with the user interface;
a code segment that provides bill payment functionality to allow the restaurant diner to pay for the food and drinks; and
a code segment that provides entertainment services to occupy the attention of the restaurant diner.

19. The computer code embodied on a computer readable medium for a customer-centric restaurant communication system from claim 18, further comprising a code segment that allows the restaurant diner to send messages to a second restaurant diner also using the restaurant communication system.

20. The computer code embodied on a computer readable medium for a customer-centric restaurant communication system from claim 18, further comprising a code segment that manages an incentive program to encourage the restaurant diner to order the food and the drinks.
